(19) United States
(12) Patent Application Publication
(10) Pub. No.: US 2003/0069985 A1
(43) Pub. Date: Apr. 10, 2003

(54) Computer readable media for storing video data

(76) Inventor: Eduardo Perez, Austin, TX (US)

Correspondence Address: SKJERVEN MORRILL LLP, THREE EMBARCADERO CENTER, 28TH FLOOR, SAN FRANCISCO, CA, 94111, US

(21) Appl. No.: 10/104,948

(22) Filed: Mar. 22, 2002

Related U.S. Application Data
(63) Continuation-in-part of application No. 09/966,876, filed on Sep. 28, 2001.
(60) Provisional application No. 60/237,404, filed on Oct. 2, 2000.

(51) Int. Cl. G06F 15/16

(52) U.S. Cl. 709/231; 709/247

(57) ABSTRACT

A computer readable medium and method are disclosed for providing streaming video by compressing the video data in a cascaded fashion. Initially, a computer system compresses video data to a first intermediate data file using a first transform. Next, the computer system compresses the first intermediate data file to a second intermediate data file using a second transform. The second intermediate data file is then compressed to a streaming video data file using a third transform. The streaming video data is then recorded onto a computer readable medium as streaming video data. In one embodiment, the first intermediate data file is an MPEG-2 data file and the second intermediate data file is an unconstrained MPEG-1 data file. The first and second transforms may be carried out in transparent mode. The video data may be stored on the computer readable medium by burning, mastering, or the like.

### CROSS REFERENCE TO RELATED APPLICATION

This application relates to and claims priority of U.S. Provisional Patent Application No. 60/237,404, entitled “METHOD FOR DELIVERY OF HIGH QUALITY STREAMING VIDEO DATA FILES OVER THE INTERNET,” filed Oct. 2, 2000 by Eduardo Pérez, and U.S. patent application Ser. No. 09/966,876, entitled “System and Method for Streaming Video Over a Network,” filed Sep. 28, 2001, the entire respective disclosures of which are incorporated herein by reference in their entireties.

### TECHNICAL FIELD

The present invention relates to video data compression and encoding. More particularly, the present invention relates to computer readable media for storing video data thereon.

### BACKGROUND

In general, video data may be considered as a sequence of “moving images” that may be displayed at a computer or other device to a viewer. Many conventional personal computers include a video player, which is a software package that decompresses the video data and sends the decompressed video data to an associated display device for viewing. The display device may comprise a cathode ray tube (CRT), a liquid crystal display (LCD), or the like.

The video player can be either an integral part of a web browser or a separate program. The video player may, alternatively, be disposed in a separate housing, such as in a set top box.

Video data stored on a DVD (Digital Versatile Disk) may also be played using a conventional DVD player and displayed on an associated display device.

However, traditional systems and methods for compressing video data for storage on optical and other storage media typically require a large amount of storage space to store a few minutes of video data.

For example, a DVD video clip encoded at about 6.5 Mbits/second requires about 46 Megabytes (MB) of storage space for each minute of video. Uncompressed video data typically requires about 2000 MB for a minute of video and compressed video data in MPEG-2 form typically requires about 7.5 MB for a minute of video.

One conventional computer readable media is a business-card size (about 5.5×8.5 cm) optical disk playable using a compact disk drive. Such disks typically have a storage capacity of about 20-50 MB. Given the limited storage capacity of such disks, these disks are typically unable to store more than about five minutes of acceptable quality video data thereon.

### SUMMARY

A need exists, therefore, for a low cost system and method for storing high quality video data on computer readable media in an efficient manner so as to permit larger amounts of video data to be stored thereon. It is also desirable that the video data be stored on the computer readable media in a manner that permits replay quality of about VHS (Vertical Helix scan) quality or better.

The present invention provides a system and method for compressing video data in a cascaded fashion to permit high quality video data to be stored on a computer readable medium in an efficient manner, while still providing replay quality of about VHS quality or better.

According to some embodiments, the computer readable medium may comprise an optical storage medium, such as a CD-ROM disk, a DVD disk, CD-ROM business card, and the like.

According to some embodiments, the present system and method initially compress video data to a first intermediate data file using a first transform. The first intermediate data file may comprise an MPEG-2 data file encoded at a data rate of more than about 5 Mbps. Next, the present system and method compress the first intermediate data file to a second intermediate data file using a second transform.

The second intermediate data file may comprise an unconstrained MPEG-1 data file. The conversion from the first intermediate data file to the second intermediate data file may de-interleave and compress the first intermediate data file by a ratio of about 2:1 or more. The second intermediate data file is then compressed and converted to a streaming video data file using a third transform. The conversion from the second intermediate data file to the streaming video data file may compress the second intermediate data file by a ratio of about 2:1 or more. The streaming video data file is then recorded onto a computer readable medium. Optionally, other data, such as long distance calling card data, text, graphics, audio, or the like may also be recorded onto the computer readable medium.

The cascading first, second, and third transforms gradually compress the video data. In one embodiment, the first and second transforms compress the video data in transparent mode. The third transform operates in transparent mode or substantially in transparent mode. Performing the first and second transforms in transparent mode significantly limits the propagation of error through the compression sequence.

Additionally, using unconstrained MPEG as an intermediate data file format permits the quality of the compressed video data in the unconstrained MPEG data file to be optimized. This may be done without being limited by the constrained MPEG parameters, such as encoding rate and form factor, that may otherwise be necessary for purposes of compatibility and interoperability.

After the video data has been compressed and converted to a streaming video data file the video data may be stored onto a computer readable storage media, such as, for example, an optical data storage device. The video data may then be played by a device, such as a personal computer, CD-ROM player, DVD player, or the like.

Optionally, the streaming video data may be transmitted over a network, such as the Internet, to a remote device, such as a client computer for display at the remote device.

Additional features and benefits of the present system and method will be apparent to those skilled in the art from the following detailed description and the accompanying drawings.

### BRIEF DESCRIPTION OF THE DRAWINGS

For a more complete understanding of the present invention and for further features and advantages, reference is now made to the following description taken in conjunction with the accompanying drawings, in which:

FIG. 1 is a computer system having a cascading compression engine, according to an embodiment of the present invention.

FIG. 2 is a data flow diagram illustrating data flow, according to an embodiment of the present invention.

FIG. 3 is a flow diagram illustrating an exemplary method of operating the cascading compression engine, according to an embodiment of the present invention.

FIG. 4 illustrates a FIG. 1 video input device according to one embodiment of the present invention.

FIG. 5 illustrates a computer system for playing video data according to one embodiment of the present invention.

### DETAILED DESCRIPTION

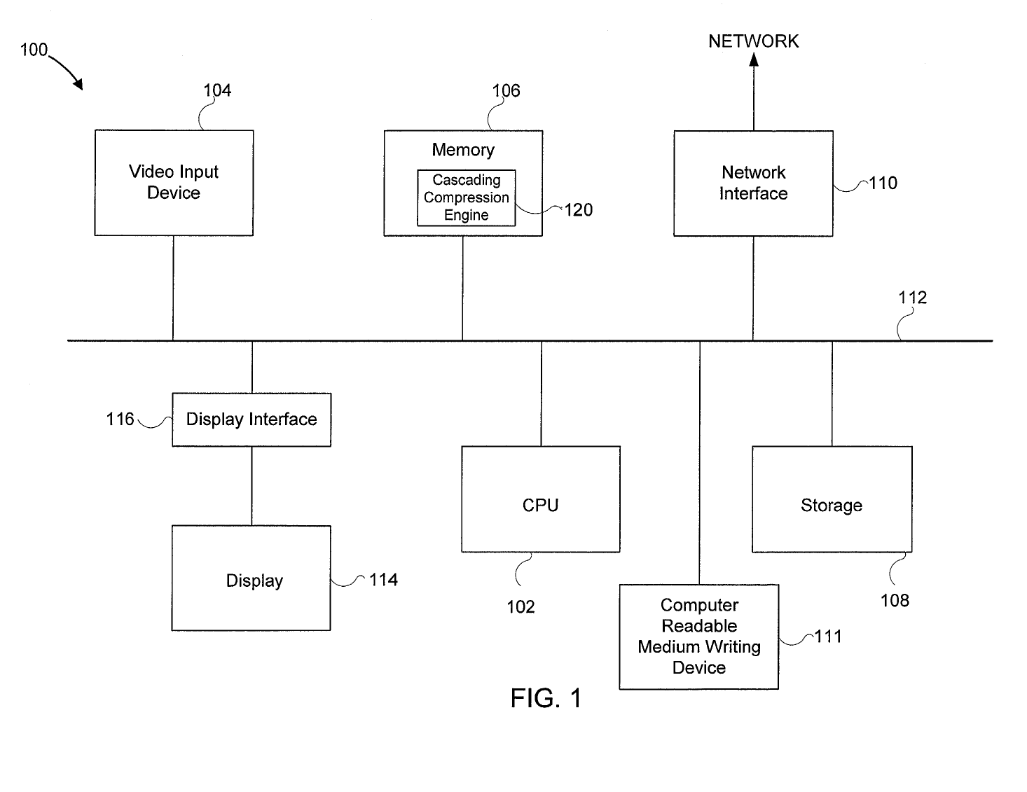

Embodiments of the present invention and their advantages are best understood by referring to FIGS. 1-5 of the drawings. Like numerals are used for like and corresponding features of the various drawings.

Definitions

Transparent mode: A mode of compressing a video data file into a compressed video data file such that, when played, a human eye is incapable of distinguishing between the video data and the compressed video data file.

Constrained MPEG file: An MPEG file wherein all parameters are within the constrained ranges set forth in the associated MPEG standard.

Unconstrained MPEG file: An MPEG file wherein all parameters are not within the constrained ranges set forth in the associated MPEG standard.

Computer Hardware

FIG. 1 illustrates a computer system 100. The computer system 100 stores video data in a streaming video data format and stores the same on a non-volatile computer readable media, such as an optical or magnetic storage disk. In an alternate embodiment, the computer system 100 may transmit the streaming video data over a network (not shown), such as the Internet, to one or more client computers (not shown). The streaming video data may be of any suitable streaming video data format, for example, ASF (Advanced Streaming Format), WMV (Windows Media Video), RM (Real Media), or the like.

In one embodiment, the streaming video data is at least of DVD-Video (Digital Versatile Disk Video) quality and is encoded at a data rate of 1-1.5 Mbps or less. In another embodiment, the streaming video data is at least of VHS quality.

Thus, the computer system 100 may store streaming video of DVD-Video quality to a computer readable medium, such as an optical disk (e.g., CD-ROM, DVD, Business Card CD-ROM, or the like).

In another embodiment, the streaming video is of HDTV (High Definition TV) quality and is encoded at bit rates of about 6 Mbps or less.

As discussed in more detail below, the streaming video data comprises video data that has undergone a plurality of data compression transforms in cascaded fashion. The data compression transforms may be conducted at the computer system 100.

In particular, FIG. 1 illustrates a computer system 100 in accordance with an example embodiment. The computer system 100 includes a central processing unit 102, a video input device 104, a memory 106, a storage device 108, a network interface 110, and a computer readable medium writing device 111, all coupled by at least one data bus 112 to permit passage of data between these devices. Optionally, the computer system 100 may also include a display 114 coupled to the bus 112 by a display interface 116.

The central processing unit 102 may comprise any of a variety of data processor devices, such as a PENTIUM III or a PENTIUM IV data processor available from Intel Corporation or one or more of a variety of data processors suitable for use in personal computers.

The video input device 104 may comprise any of a variety of video input devices that are able to output video data as an MPEG-2 data file. For example, the video input device 104 may comprise a digital video recorder, a DVD-Video disk and drive, a video camera, a Beta SP or S-VHS videocassette and videocassette player, a video capture card, a combination of the foregoing, or the like.

In one embodiment, the video input device 104 outputs an unconstrained MPEG-2 data file, which is not limited by the constraint parameters, such as bit rate, of constrained MPEG-2. Thus, the video input device 104 receives video data and converts the video data into an intermediate data file, such as an unconstrained MPEG-2 data file, using an MPEG-2 compression transform to compress the video data in transparent mode. Optionally, the video input device 104 may output a constrained MPEG-2 data file.

The memory 106 may comprise non-volatile memory or a combination of volatile and non-volatile memory and includes a cascading compression engine 120. As discussed in more detail below, the cascading compression engine 120 receives a first intermediate data file from the video input device, such as either a constrained or an unconstrained MPEG-2 data file, and converts the first intermediate data file into a second intermediate data file using a compression transform. In one embodiment, this compression transform is an MPEG-2 to unconstrained MPEG-1 transform and converts the first intermediate data file from MPEG-2 format to a second intermediate data file in unconstrained MPEG-1 format in transparent mode.

MPEG-1 and MPEG-2 standards and compression techniques are well-known. Details regarding MPEG-1 and MPEG-2 standards and compression techniques are set forth in the following International Organization for Standardization publications: ISO/IEC 11172 (MPEG-1)and ISO/IEC 13818 (MPEG-2), both of which are incorporated herein by reference. Additional details regarding MPEG-1 and MPEG-2 standards and compression techniques are found in MPEG Video Compression Standard, by Mitchell, et al., ISBN 0-412-08771 (Chapman & Hall, 1996), the disclosure of which is incorporated herein by reference.

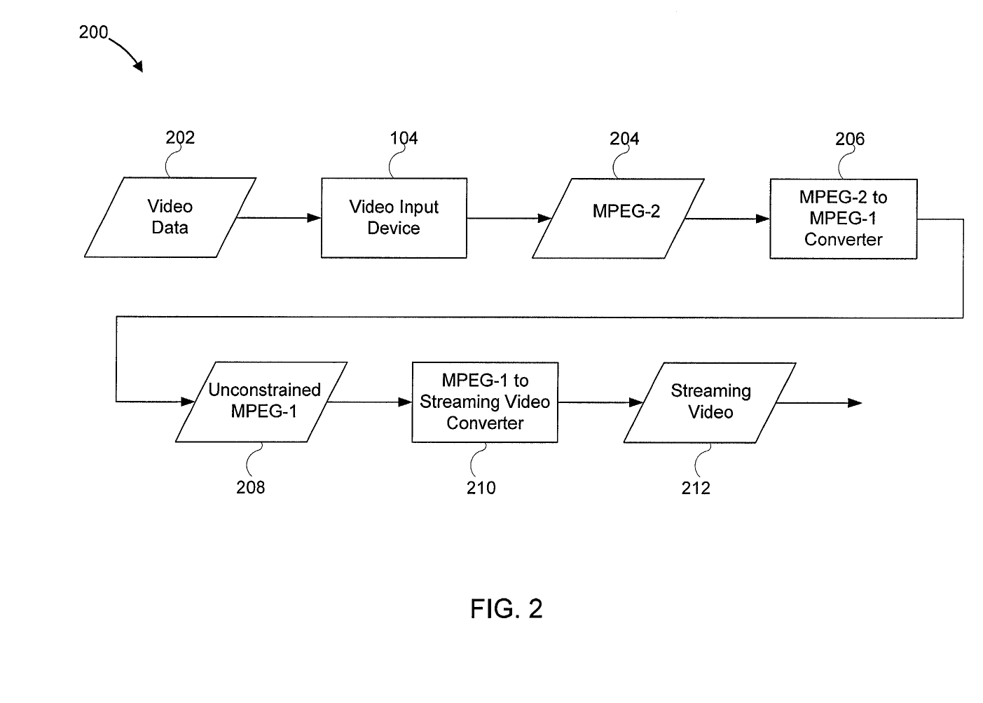

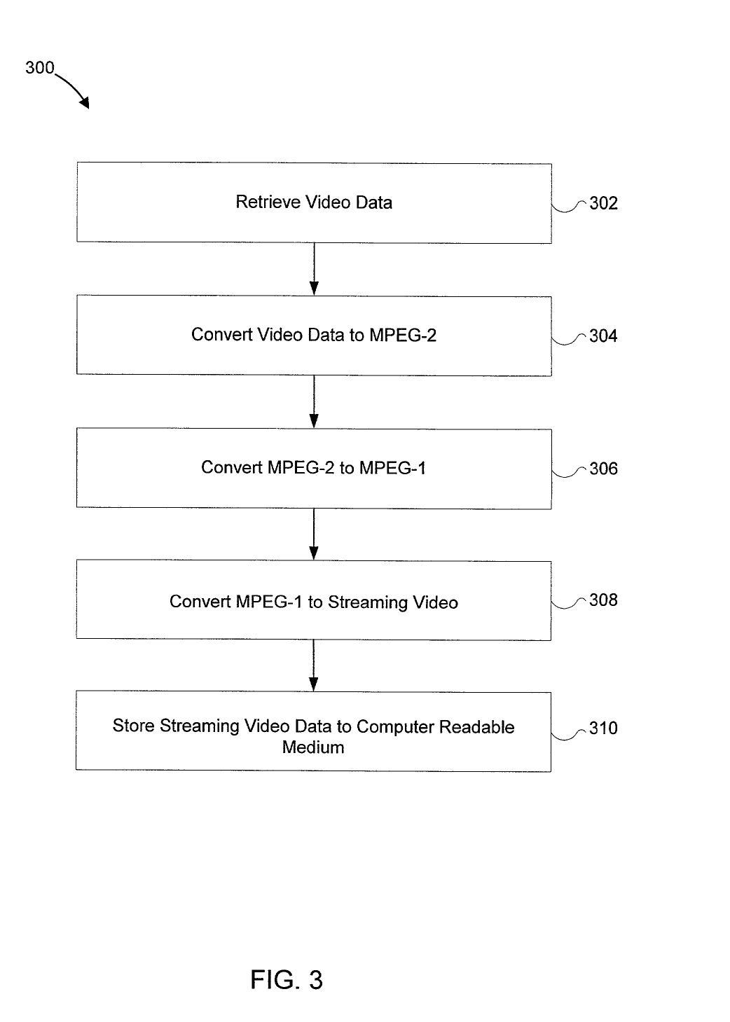

The cascading compression engine 120 then converts the second intermediate data file into a streaming video data file. In one embodiment, the cascading compression engine 120 converts the second intermediate data file from an unconstrained MPEG-1 format to a streaming video data file having in a format such as ASF, WMV, or RM. Additional details regarding the cascading compression engine 120 are illustrated in FIGS. 2 and 3 and are discussed below.

The storage device 108 may comprise a non-volatile memory having sufficient storage space to store the first and second intermediate data files and the streaming video data file described above.

The network interface 110 is optional and may serve to interface the computer system 100 with a network (not shown) for permitting the exchange of data between the computer system 100 and the network.

The computer readable medium writing device 111 serves to write the video data, as compressed and encoded by the cascading compression engine 120 to a computer readable medium. In one embodiment, the computer readable medium writing device 111 comprises a device that uses a laser to burn the video data onto a computer readable media, such as an optical disk. Example devices of this type include a CD-R (CD-Recordable) drive, a CD-RW (CD-Rewritable) drive, a DVD-R (DVD-Recordable) drive, or the like.

Alternatively, the video data may be reproduced, or pressed, onto an optical disk using conventional optical disk mastering and reproducing techniques.

Optionally, the computer system 100 may include a display 114 coupled to the data bus 112 by a display interface 114. The display 114 may comprise a CRT (Cathode Ray Tube), a liquid crystal device, or the like. In embodiments where the display 114 comprises a computer monitor, the display interface 116 may comprise a video card for interfacing the display 114 with the data bus 112. In embodiments where the display comprises a television set, the display interface 116 may comprise a VGA-NTSC scan converter. The display 114 may be used to display the MPEG-2 data file, the unconstrained MPEG-1 data file, the streaming data file, or the like.

Cascading Compression

FIG. 2 is a data flow diagram 200 illustrating one embodiment of the present invention. FIG. 3 is a flow chart 300 illustrating one embodiment of a method associated with the FIG. 2 data flow diagram. FIGS. 2 and 3 illustrate details of the operation of the cascading compression engine 120 (FIG. 1).

Referring now to FIGS. 2 and 3, the method begins by retrieving video data 202 (FIG. 2) pursuant to block 302 (FIG. 3). The video data 202 may comprise 4:2:2, 4:1:1, or 4:2:0 video, which is uncompressed raw video with no sub-sampling and where Y, Cb, and Cr video components are sampled equally. The video data 202 may be retrieved by the video input device 104 (FIG. 1).

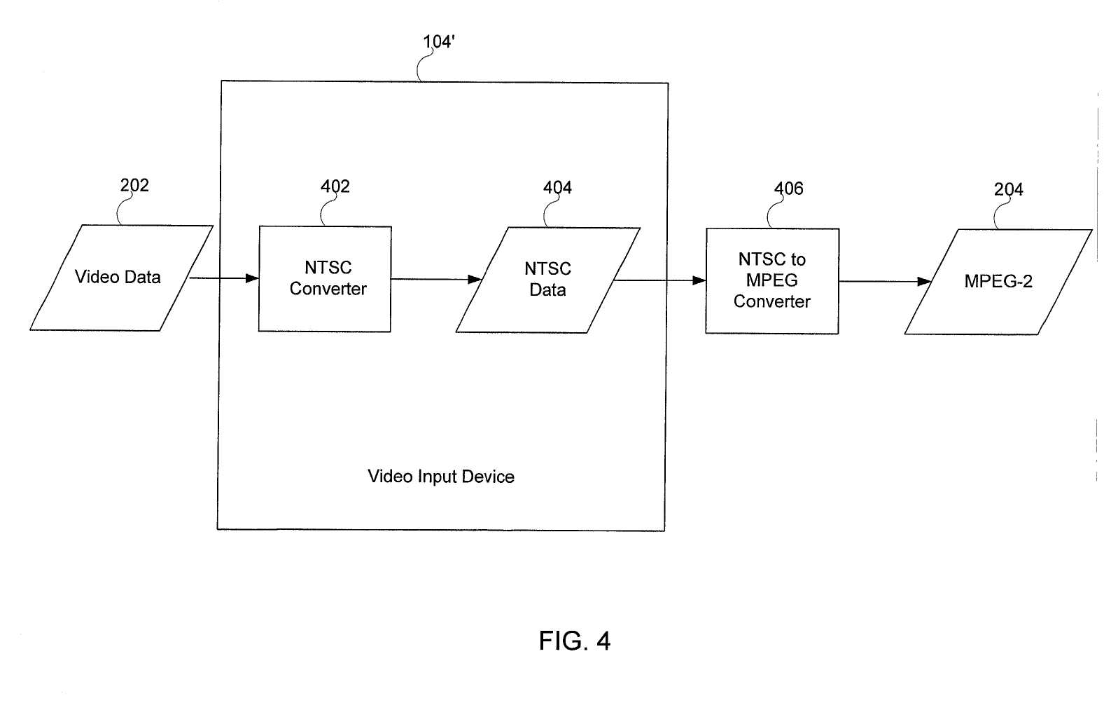

As shown in FIG. 4, the video input device 104 (FIG. 2) may comprise, according to one embodiment, a video camera 104′, which receives the video data 202 and outputs an NTSC (National Television Systems Committee) data 404 to an NTSC to MPEG-2 converter 406. The NTSC to MPEG-2 converter 406 may comprise a video capture card, which receives the NTSC format video data 404 and converts the NTSC format video data 404 to the MPEG-2 data file 204, pursuant to block 304 (FIG. 3).

In converting the video data 202 into NTSC format video data 404, the video camera 104′ compresses the video data 202 by about a 3:2 conversion. In converting the NTSC format video data 404 into the MPEG-2 data file 204, the NTSC to MPEG converter 406 compresses the NTSC format video data 404 by about a 30:1 conversion.

The video camera 104′ may comprise any of a variety of conventional video cameras, which record raw video data and convert the same to NTSC data, which may then be captured by the NTSC to MPEG converter 406 and converted to an MPEG-2 data file. For example, the video camera 104′ may comprise a conventional DV (Digital Video) camera.

In another embodiment, the video input device 204 (FIG. 1) comprises a DVD-Video disk and disk drive (not shown). Pursuant to this embodiment, the DVD-Video disk has video data stored thereon as one or more MPEG-2 files and outputs the MPEG-2 data file 204 (FIG. 2). In one embodiment, the MPEG-2 data file is encoded at a data rate in the range of about 4-6 Mbps. In another embodiment, the MPEG-2 data file 204 is encoded at a data rate in the range of 9-12 Mbps. The MPEG-2 data file 404 may be of broadcast, VHS, or DVD film quality, for example.

In yet another embodiment, the video input device 104 may comprise an MPEG-2 video capture card coupled to a Beta SP or S-VHS videocassette and videocassette player (not shown). Pursuant to this embodiment, the videocassette has high-quality video data stored thereon, which is captured by the video capture card. The video capture card captures the video data stored on the videocassette and converts the same to an MPEG-2 data file, such as the MPEG-2 data file 204, pursuant to block 304 (FIG. 3).

Next, an MPEG-2 to MPEG-1 converter 206 converts the MPEG-2 data file 204 to an unconstrained MPEG-1 data file 208 in transparent mode, pursuant to block 306 (FIG. 3). In converting the MPEG-2 data file 204 to an unconstrained MPEG-1 data file 208 the MPEG-2 to MPEG-1 converter 206 compresses the MPEG-2 data file 204 by a ratio in the range of about 1.5:1 to 6:1, depending on the application. The unconstrained MPEG-1 data file 208 is in unconstrained format, meaning that the MPEG-1 data file is not compliant with all the MPEG-1 constraints. In addition, the MPEG-2 to MPEG-1 converter 206 converts the MPEG-2 data file 204 to the unconstrained MPEG-1 data file 208 in transparent mode.

In one embodiment, the MPEG-2 to MPEG-1 converter 206 converts the MPEG-2 data file 204 to the MPEG-1 data file 208 at about 6 Mbps at 30 frames per second for broadcast quality and 24 frames per second for film. In addition, if the MPEG-2 data file 204 comprises interlaced video data, the MPEG-2 to MPEG-1 converter 206 de-interlaces the interlaced video data.

The MPEG-2 to MPEG-1 converter 206 may comprise any of a variety of conventional MPEG-2 to MPEG-1 converter software packages such as FLASKMPEG, MPEG-1 ENCODER by Panasonic, DVD2MPEG, or the like. The MPEG-2 to MPEG-1 converter comprises a part of the cascading compression engine 120 (FIG. 1).

Next, pursuant to block 308 (FIG. 3), an MPEG-1 to streaming video converter 210 (FIG. 2) converts the unconstrained MPEG-1 data file 208 to streaming video 212. In converting the unconstrained MPEG-1 data file 208 to streaming video 212 the unconstrained MPEG-1 to streaming video converter 210 may compress the unconstrained MPEG-1 data file 208 at a ratio in the range of about 2:1 to 3:1 for transparent mode and up to about 40:1 for non-transparent mode. The streaming video 212 may comprise a streaming video format such as ASF, WMV, RM, or other suitable streaming video format. The streaming video 212 may be stored by the computer system 100 (FIG. 1) at the storage device 108, the memory 106, and the computer readable medium writing device 111.

The MPEG-1 to streaming video converter 410 may comprise any of a variety of suitable MPEG-1 to streaming video converters, such as WINDOWS MEDIA from Microsoft Corporation, REAL PRODUCER from Realnetworks, Inc., STREAM ANYWHERE, from Sonic Foundry, Inc. The MPEG-1 to streaming video converter 210 may comprise a part of the cascading compression engine 120 (FIG. 1).

Next, pursuant to block 310 (FIG. 3), the computer system 100 stores the streaming video 212 to a computer readable medium using the computer readable medium writing device 111. The computer system 100 may also store the streaming video data at the memory 106 and the storage device 108 (FIG. 1). In one embodiment, the computer system 100 stores the streaming video 212 at a data rate less than about 1.5 Mbps. In another embodiment, the computer system 100 stores the streaming video 212 at a data rate less than about 6 Mbps.

In addition to storing video data on the computer readable medium as described above, other data may also be stored on the computer readable medium. This other data may include, for example, telephone long distance calling card data, marketing data, links to Internet web sites and email, graphics data, audio data, and the like.

Alternatively, the computer system 100 may also transmit the video data over a network via the network interface 110 (FIG. 1).

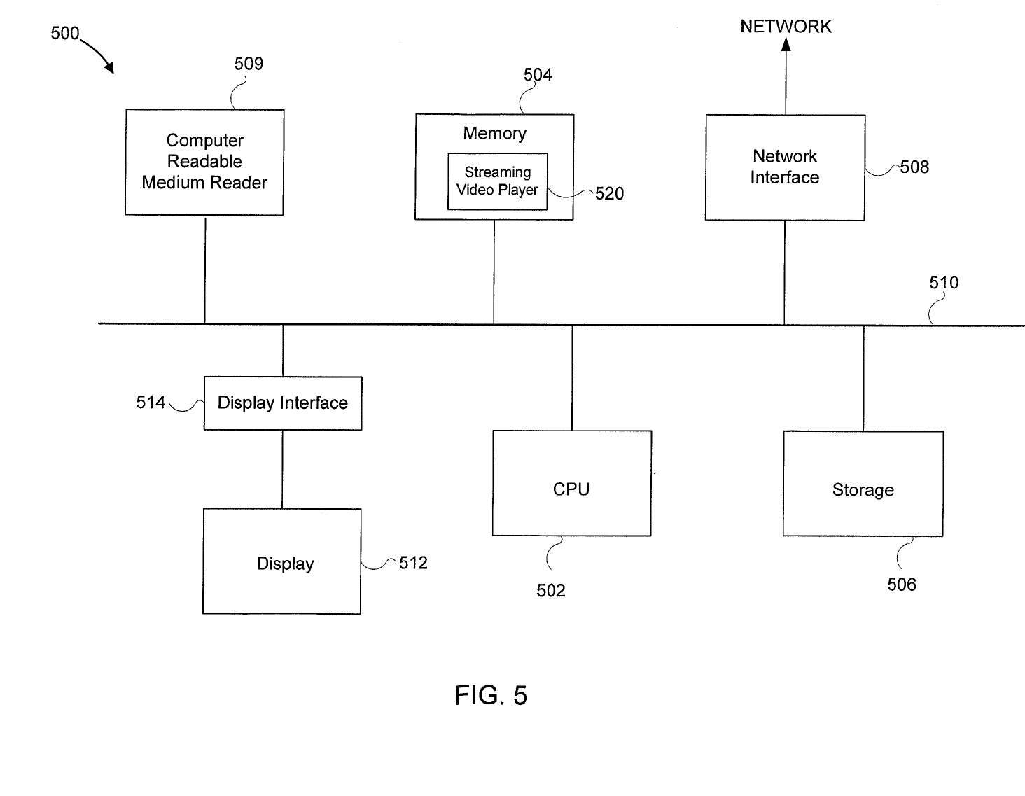

FIG. 5 illustrates details of one embodiment of a computer system 500 for playing streaming video data. The computer system 500 may receive streaming video data from computer readable media, such as an optical disk, disposed within a computer readable medium reader, such as an optical disk drive or the like.

The computer system 500 is shown as having a central processing unit 502, a memory 504, a storage device 506, a network interface 508, and a computer readable medium reader 509, all coupled by at least one data bus 510 to permit passage of data between these devices. Optionally, the client computer 500 may also include a display 512 coupled to the data bus 510 by a display interface 514.

The central processing unit 502 may comprise any of a variety of data processor devices, such as a PENTIUM III or PENTIUM IV data processor available from Intel Corporation or one or more of a variety of data processors suitable for use in personal computers.

The memory 504 may comprise non-volatile memory or a combination of volatile and non-volatile memory and includes a streaming video player 520. As discussed in more detail below, the streaming video player 520 receives streaming video data from computer readable media via the computer readable media reader 509 and plays, or displays, the streaming video data on the display 512.

The streaming video player 520 may comprise WINDOWS MEDIA PLAYER streaming media player, available from Microsoft Corporation or REALPLAYER streaming media player, available from RealNetworks, Inc., or the like. Moreover, the streaming video player 520 may comprise an integral part of a web browser or may comprise a distinct program.

The storage device 506 may comprise a non-volatile memory device.

The network interface 508 is optional and operates to interface the computer system 500 with a network (not shown) for permitting the exchange of data between the computer system 500 and the network. The network interface 508 may comprise a network interface card, a modem, or the like.

Optionally, computer system 500 may include a display 512 coupled to the data bus 510 by a display interface 514. The display 512 may be similar to the display 114 described above and the display interface 514 may be similar to the display interface 116 described above.

Lastly, the streaming video player 520 (FIG. 5) plays the received streaming video at the computer system 500. 5). The streaming video player 520 causes the streaming video to be displayed at the display 512. Optionally, the computer system 500 may store the streaming video, as a data file at the storage device 506 for later playing.

While particular exemplary embodiments have been shown and described, it will be apparent to practitioners that various changes and modifications may be made without departing from our invention in its broader aspects. Accordingly, the appended claims encompass all such changes and modifications as fall within the scope of this invention.

What is claimed is:

1. A computer readable medium comprising streaming video data created by a method comprising:
compressing video data to a first intermediate data file using a first transform;
compressing the first intermediate data file to a second intermediate data file using a second transform;
compressing the second intermediate data file to a streaming video data file using a third transform;
recording the streaming video data file to a computer readable medium.

2. The computer readable medium according to claim 1, wherein the computer readable medium further comprises an optical disk.

3. The computer readable medium according to claim 1, wherein the method further includes recording calling card information on the computer readable medium.

4. The computer readable medium according to claim 1, wherein the computer readable medium comprises a circular circumference.

5. The computer readable medium according to claim 1, wherein the computer readable medium comprises a rectangular circumference.

6. The computer readable medium according to claim 1, wherein the first intermediate data file further comprises an MPEG-2 data file and the second intermediate data file further comprises an unconstrained MPEG-1 data file, the compressing the first intermediate data file to a second intermediate data file further comprising converting the MPEG-2 data file to the unconstrained MPEG-1 data file.

7. The computer readable medium according to claim 1, wherein the method further comprises de-interlacing the first intermediate data file using the first transform.

8. The computer readable medium according to claim 1, wherein the first intermediate data file is encoded at a rate of 5 Mbps or more.

9. The computer readable medium according to claim 1, wherein the streaming data file is encoded at a rate of 1.5 Mbps or less.

10. The computer readable medium according to claim 1, wherein the first intermediate data is encoded at about 30 frames per second and wherein the compressing the first intermediate data file to a second intermediate data file using a second transform further includes encoding the second intermediate data file at about 30 frames per second or less.

11. The computer readable medium according to claim 1, wherein the compressing the first intermediate data file to a second intermediate data file using a second transform is performed in transparent mode.

12. A computer readable medium comprising streaming video data created by a method comprising:
converting video data to an MPEG-2 data file using a first transform;
converting the MPEG-2 data file to an unconstrained MPEG-1 data file using a second transform;
converting the MPEG-1 data file to a streaming video data file using a third transform.

13. The computer readable medium according to claim 12, wherein the converting the MPEG-2 data file to an unconstrained MPEG-1 data file using a second transform is performed in transparent mode.

14. The computer readable medium according to claim 12, wherein the MPEG-2 data file is encoded at a rate of 5 Mbps or greater.

15. The computer readable medium according to claim 12, wherein the video data further comprises NTSC format video data.

16. The computer readable medium according to claim 12, wherein the method further comprises de-interlacing the first intermediate data file using the first transform.

17. The computer readable medium according to claim 12, wherein the converting the first intermediate data file to a second intermediate data file using a second transform is performed in transparent mode.

18. The computer readable medium according to claim 12, wherein the first intermediate data is encoded at about 30 frames per second and wherein the converting the first intermediate data file to a second intermediate data file using a second transform further includes encoding the second intermediate data file at about 30 frames per second or less.

19. The computer readable medium according to claim 12 further comprising calling card information stored on the computer readable medium.
